(19) United States
(12) Patent Application Publication
(10) Pub. No.: US 2021/0094343 A1
(43) Pub. Date: Apr. 1, 2021

(54) DECORATIVE CONCRETE SIMULATING NATURAL WOOD AND METHOD OF FORMING THE SAME

(71) Applicant: Shaw & Sons, Inc., Costa Mesa, CA (US)

(72) Inventors: Ronald D. Shaw, Costa Mesa, CA (US); Marshall John Barabasch, San Bernardino, CA (US)

(21) Appl. No.: 17/116,814

(22) Filed: Dec. 9, 2020

Related U.S. Application Data
(63) Continuation of application No. 16/287,864, filed on Feb. 27, 2019.
Application No. 16/287,864 is a continuation of application No. 14/969,442, filed on Dec. 15, 2015, now abandoned.

(51) Int. Cl. B44F 9/02; E04B 5/44; E04G 21/10; E02D 27/08; B44C 1/22; B44D 5/10

(52) U.S. Cl. CPC B44F 9/02; E04B 5/44; E04G 21/10; E04B 2103/02; B44C 1/224; B44D 5/10; E02D 27/08

(57) ABSTRACT

A decorative concrete structure simulating natural wood and a method of fabricating the same is disclosed. A concrete mixture is poured over a subgrade which defines an exposed surface. The exposed surface is swept with a broom, saw cut, and optionally stained, and sealed to simulate aesthetic appearance of the natural wood.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### Field of the Invention

The present invention relates in general to concrete products, and more particularly, to a method of creating decorative concrete simulating the appearance of natural wood and the method of forming the same.

### Description of the Related Art

As is well known in the building and construction trade, concrete is extensively utilized as a building material for commercial and residential applications. In this regard, due to its durability, water resistance, and cost economy, concrete has gained widespread use. With this widespread use, there is a demand for decorative concrete that possesses improved aesthetics similar to conventional wood plank and/or wood decking.

Although numerous types of conventional decorative concrete has been developed in prior art, such as salt finish, broom finish, and form pressed finish (i.e. stamp concrete), the use of such conventional techniques have typically failed to provide the necessary simulation, i.e. aesthetics, of the resultant concrete surface to mimic the appearance and aesthetics of conventional wooden deck structures. In this regard, although conventional stamp concrete has attempted to mimic the appearance of wood deck products, such attempts have been generally unsuccessful, especially when the particular wood deck structure includes a very fine wood grain aesthetic associated with wood such as epay and/or mahogany. Further, conventional stamp concrete molds typically provide too large of an impression into the top surface of the concrete to simulate such fine grain woods. In addition, the cost of manufacturing such stamp concrete molds, as well as the cost associated in forming decorative concrete utilizing such stamp concrete molds, has been prohibitive.

As such, there exists a need in the art for decorative concrete simulating the appearance of natural wood, as well as an economical method of forming the same. Various aspects of the present invention are specifically directed toward addressing these particular needs as will be discussed in more detail below.

### BRIEF SUMMARY

According to various aspects of the present invention, there is provided a method of forming decorative concrete simulating natural wood and natural wood decking, as well as a method of forming the same. The method of the present invention is more cost effective than conventional decorative concrete and further provides improved aesthetics to closely simulate the appearance of natural wood and natural wood planking.

The method of forming the decorative concrete of the present invention contemplates pouring a concrete mixture within forms as is conventional within the art. Conventional screeding and floating of the concrete is additionally provided. However, prior to set-up/hardening of the concrete, the top exposed surface of the concrete is finished utilizing a broom, which is swept across the top surface of the exposed concrete to leave impressions/depressions in the top surface thereof. These fine impressions/depressions simulate the appearance of natural wood grain and wood decking. The broom finish can be formed in a generally longitudinal or parallel orientation, or alternatively, various wave shapes may be formed in the top surface of the exposed concrete to better simulate a particular desired wood grain. Optionally, a conventional concrete trowel may be lightly pressed over the surface to flatten out the exposed surface to create a surface look of wood decking. Once broom finished, the concrete is allowed to cure or partially cure wherein the exposed surface is hardened.

The present invention additionally contemplates the formation of a wood lumber or decking pattern being saw cut into the top surface of the exposed concrete. Typically, this cutting process includes forming a plurality of generally parallel saw cuts having a depth as shallow as 1/16 of an inch to ½ of an inch and preferably ⅜ of an inch deep. The width the saw cut can be formed as desired, but typically is between 1/16 and ¼ of an inch, and preferably 3/16 of an inch. The plurality of saw cuts gives a visual appearance to the top surface of the concrete simulating a conventional wooden deck. Perpendicular cross cuts can be added to represent the end cuts of a wooden deck. The edge of such saw cuts can optionally be stoned, ground, or sanded to better represent the soft edge of conventional wood lumber.

To better simulate the look of conventional wood decking, one or more conventional concrete stains can be applied to the top surface of the exposed concrete. Differing concrete stains can be applied to simulate mold and grain, and such stains can either be lightly sprayed or dry brushed to provide darkened streaks simulating wood grain. After the optional stain is applied to the top surface of the concrete, the top surface can optionally be lightly sanded, scrubbed, and/or ground to mimic the surface finish of conventional wood decks. Subsequently, an optional concrete sealer may be applied to reduce wear and/or UV damage to the concrete surface.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a perspective cross sectional view of the decorative concrete structure of the present invention;

FIG. 2 illustrates the use of a broom tool to form an impressed/depressed wood grain pattern on the top surface of the decorative concrete structure;

FIG. 2A illustrates a cross-sectional view of the decorative concrete structure taken along line 2-2 of FIG. 1;

FIG. 3 illustrates an enlarged view of a decorative groove of the decorative concrete structure of FIG. 2; and

FIG. 4 illustrates the resultant decorative concrete structure 10 exhibiting the simulated appearance of a natural wood deck.

### DETAILED DESCRIPTION

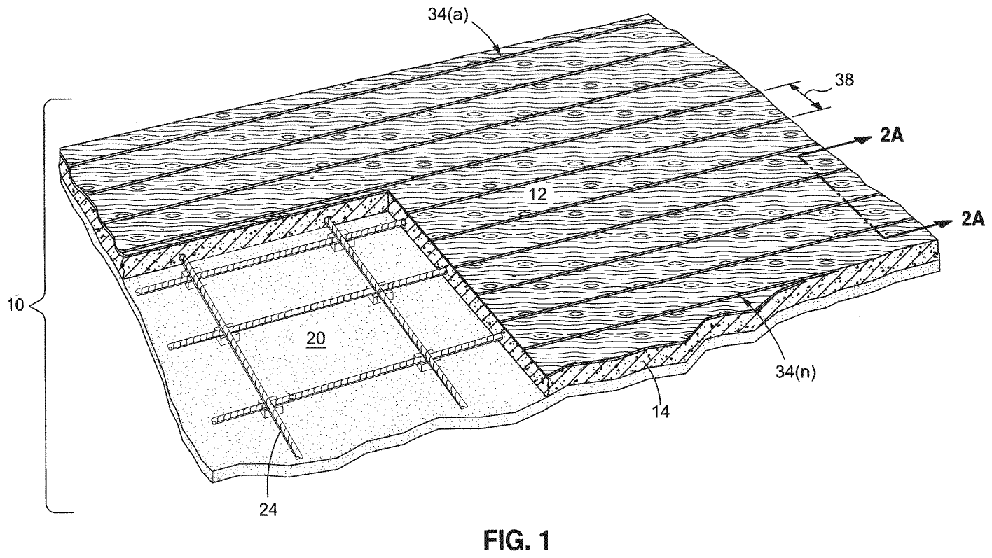

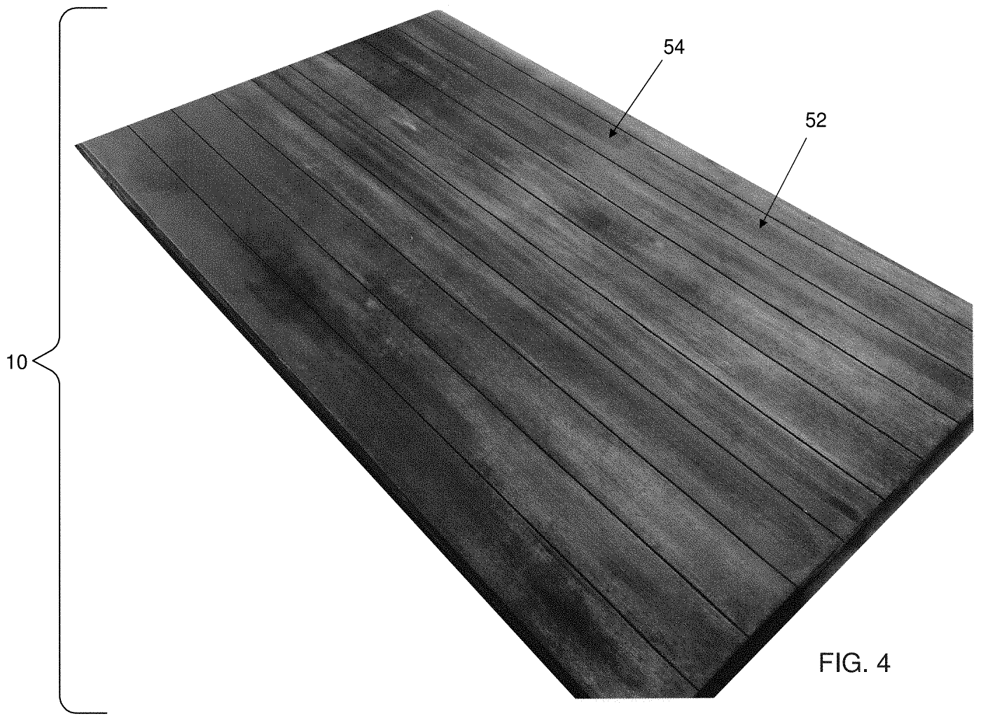

Referring now specifically to the drawings, the decorative concrete structure 10 of the present invention simulating natural wood and the method for preparing the decorative concrete structure 10 is shown. Various aspects of preparing the decorative concrete structure 10 results in the decorative concrete structure 10 which simulates the fine grain textures of the natural wood. For instance, the resultant decorative concrete structure 10 simulates a wood grain finish that is typically found in conventional natural wood decks such as epay and mahogany (see FIG. 4). In the method, a brooming tool 30, i.e. broom, is used to sweep upon the top exposed surface 12 and imprint the exposed surface 12 of an uncured concrete mixture 14 to create patterns that resembles wood grain that are found in the natural wood. To replicate abutted planks found in the conventional natural wood decks, a plurality of longitudinal and preferably parallel saw cut lines 34a-n are formed on the exposed surface 12 of the decorative concrete structure 10 (see FIG. 1). The exposed surface 12 may then be treated with a base stain 52, top coat of stain 54, and preferably a sealer to achieve the desired aesthetic appearance of a natural wood deck.

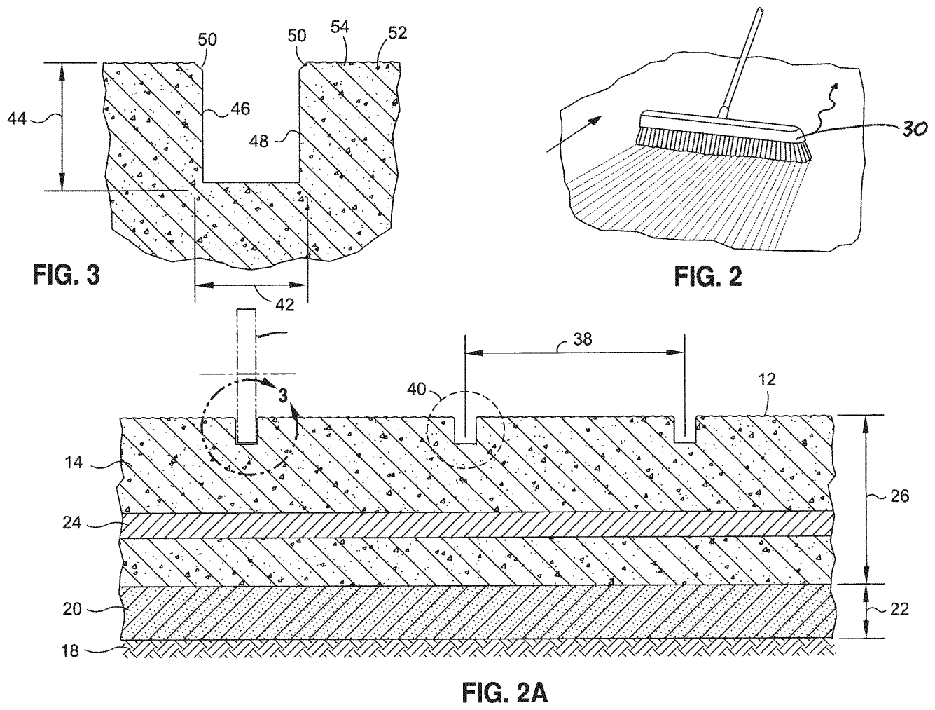

The initial step in forming the decorative concrete structure 10 comprises preparing a subgrade 18 (see FIG. 2). The subgrade 18 provides uniform support for the decorative concrete structure 10. Typically, the initial step involves excavating the ground to a desired elevation and compacting the ground preferably to 90% compaction to ensure a uniform and stable support. After compacting the subgrade 18, the subgrade 18 may be covered with a layer of clean, moist, fill sand 20 which preferably defines a minimum thickness 22 of approximately four inches (see FIG. 2). Although the fill sand 20 is not necessary for the method of producing the decorative concrete structure 10, it is desirable to control the hydration process of the decorative concrete structure 10.

After preparing the subgrade 18, conventional forms or form members (not shown) may be placed upon the perimeter of the subgrade 18 to create a cavity within which the concrete mixture 14 is poured. As is well known, the form members create a solid barrier that maintains the concrete mixture 14 in place and forces the concrete mixture 14 to assume a desired external configuration. The form members may be fabricated from plywood, plastic, aluminum, steel, or other materials known in the art. The form members define a pour boundary that may be held together by mechanical fasteners. As is well known, when the concrete mixture 14 is hardened/cured, the form may be removed.

After preparing the forms for the decorative concrete structure 10, reinforcing members 24 such as rebars or a wire mesh may be used to increase the resultant strength of the decorative concrete structure 10 (see FIGS. 1 and 2). The reinforcing members 24 mitigate the likelihood of cracking within the decorative concrete structure 10. The reinforcement members 24 may be positioned over the layer of fill sand 20 to define a lattice framework, or other arrangements known by those skilled in the art.

After the reinforcing members 24 are placed, a concrete mixture 14 is poured over the fill sand 20 and reinforcing members 24 so that the reinforcing members 24 are disposed within and encapsulated within the concrete mixture 14 (see FIG. 2). The concrete mixture 14 is preferably poured to define a depth 26 of approximately 3.5-4.0 inches, however, other depths 26 are also contemplated. Although variations in the concrete mixture 14 are contemplated, the preferred concrete mixture 14 comprises 70% sand and 30% aggregate combined with portland cement preferably (2,000 pounds per square inch) or (3,000 pounds per square inch). Further, depending on desired aesthetics of the exposed surface 12, an integral color additive may be added to the concrete mixture 14 to achieve the desired appearance.

After the concrete mixture 14 has been poured, the top surface of the concrete mixture 14 is screeded to produce a flat surface that defines the exposed surface 12. The top surface of the concrete mixture 14 is screeded to remove excess concrete and to bring the top surface of the concrete mixture 14 to a desired plane or grade determined by the form members.

After screeding the excess concrete mixture 14 to the desired flute, plane or grade, the exposed surface 12 may be surfaced or finished with a conventional finishing tool to dispose a quantity of the cement/fine paste derived from the concrete mixture 14 at the exposed surface 12 thereof. For example, a float tool such as a bull float or vibrating bull float may be used to create a smooth upper surface and to remove surface imperfections. In addition to bringing up the appropriate amount of cement/fine paste, the float may seal the exposed surface 12 of the concrete mixture 14. An exemplary metal bull float is sold under the trademark HAL200 by the Lievers Holland Co. although other floats are contemplated herein.

After finishing with the float tool, a conventional trowel tool may be applied to the exposed surface 12. The troweling may be accomplished by a trowel machine or manually by a hand trowel.

While the exposed surface 12 of the concrete mixture 14 is still in a plastic state, a user (not shown) may use a brooming tool 30, i.e. broom, to sweep the exposed surface 12 to create patterns therein that resemble wood grain found in natural wood. For example, a brooming tool such as a push broom 30 may be used to repeatedly sweep the exposed surface 12 in horizontal and lateral directions (as indicated by the curved arrow in FIG. 2) until the desired look of the natural wood grain is achieved. Sweeping the exposed surface 12 leaves an impression/depression pattern formed by the bristles of the push broom as the bristles pass across the exposed surface 12. The resultant pattern created by the broom provides grain patterns that resemble natural wood. Also, specific brooming techniques such as pulling the broom in a small wave pattern (as indicated by the curved arrow in FIG. 2) may be implemented to achieve the desired grain appearance. To achieve the desired aesthetic appearance of the natural wood, the user may use other brooming tools 30 that may have a different type of bristle such as natural bristle or nylon or other polymer bristles. For instance, differing brooming tools may provide variations in depth, size, or width to achieve a desired grain pattern. Furthermore, varying the downward pressure or broom angle upon the exposed concrete surface can achieve differing wood grain appearance.

In an optional step, after sweeping the exposed surface 12 with the brooming tool, a conventional trowel (not shown) may be used to lightly pass over the exposed surface 12 to flatten out the exposed surface 12 to create the look of the natural wood after being processed into conventional planks (i.e., lumber).

After the exposed surface 12 has been broom finished, the concrete mixture 14 may be properly hardened/cured by protecting the concrete mixture 14 from losing moisture and to keep it within reasonable temperature ranges. For example, the concrete mixture 14 may be hardened/cured utilizing water alone, or by using chemical curing agents. The hardening/curing process utilizing water alone may be facilitated through the use of a conventional fogger or soaker hose. After a prescribed period of time (typically 2-10 days) any surface residue present on the exposed surface 12 may be optionally removed by conventional power washing with preferably a ninety percent (90%) steam and ten percent (10%) muriatic acid mixture which is applied by a power washer via a high pressure nozzle.

After hardening/curing the concrete mixture 14, a desired pattern may be cut into the exposed surface 12 with a conventional concrete saw. Preferably, the pattern is cut into the exposed surface 12 after the concrete mixture 14 has been fully hardened/cured; however, it is also contemplated that the cutting step may occur before the concrete mixture 14 has been fully hardened/cured.

The pattern may be created by using a conventional concrete saw tool schematically illustrated by the phantom lines 31 shown in FIG. 2A to cut a plurality of longitudinal and preferably generally parallel cuts 34a-n into the exposed surface 12 (see FIG. 1). After the plurality of longitudinal cut lines 34a-n are formed, the pattern simulates a plurality of planks typically found in conventional natural wood decks. Preferably, the pattern may additionally have longitudinal cut lines 34a-n that are equally spaced from each other. A preferable spacing 38 (center to center) between each longitudinal cut 34 may be varied as desired but preferably comprised 5.5 inches to simulate conventional six by wooden planks (see FIGS. 1 and 2). It is also contemplated that the saw cut pattern be created by cutting into the exposed surface 12 by any other type of pattern such as random, diagonal, parquet, herringbone, or any other pattern known in the art.

Each one of the plurality of longitudinal cut lines 34a-n defines a groove 40 (see FIGS. 2A and 3). The grooves 40 have a width 42, depth 44, and is formed by a first wall 46 and second wall 48. The width 42 of the groove 40 is preferably approximately 0.1875 inch, although the width 42 may also be any other size. The depth 44 may range from 0.125 inch to full-depth, although the depth 44 is preferably approximately 0.375 inch.

The groove 40 is formed by the first and second walls 46, 48 (see FIG. 3). The first and second walls 46, 48 may be planar and parallel to each other. However, the first and second walls 46, 48 may also be curved or angled.

A transitional edge 50 may be formed by the exposed surface 12 and its respective wall, the first wall 46 or second wall 48 (see FIG. 3). To replicate the look of the natural wood planks, the transitional edge 50 may be chamfered to create a smooth or rounded edge. Conventional tools such as a stone grinder or sanding tool may be used to chamfer the transitional edge 50. However, any other tools known in the art may be used to create the chamfer along the transitional edge 50.

After the cutting and chamfering step, as an optional step, one or more conventional concrete stains 52 may be applied to the exposed surface 12 of the decorative concrete structure 10 (see FIG. 3). The base stain or stains 52 may create a consistent color so that the exposed surface 12 does not appear blotchy and uneven in appearance or may provide color differences to simulate the desired type of wood aesthetics.

Subsequent to applying the optional base stain 52, the exposed surface 12 may optionally be sanded, scrubbed, or ground to further mimic the surface of finished lumber. Furthermore, this step advantageously knocks off most of the sand particles that may be disposed upon the exposed surface 12. In this procedure, it may be preferable to lightly sand the exposed surface 12. Lightly sanding the exposed surface 12 may be done according to the design requirements in creating an appearance of the natural wood decks.

Following sanding the exposed surface 12, an additional top coat of stain 54 may optionally be applied to the exposed surface 12 (see FIG. 3). When the top coat of stain 54 is applied, it may enhance the desired aesthetic appearance and resemble natural wood decks such as epay, mahogany, redwood, cedar, or any other natural wood deck that is desired. Furthermore, the appearance of grain color variances in the natural wood decks may also be replicated. This step may be performed by lightly spraying or dry brushing one or more dark stains in patterns or lines on the exposed surface 12 to achieve the desired look of the mold and stain.

Additional layers of stain 54 may be applied to the exposed surface 12 until the desired aesthetic appearance of the natural wood deck is achieved. After the exposed surface 12 is stained, an optional conventional concrete sealer may be applied to the exposed surface 12 to preserve life of the decorative concrete structure 10.

The resultant decorative concrete structure 10 exhibits an appearance of a conventional natural wood deck as shown in FIG. 4. The wood grains that are typically found in tight grained natural wood such as epay and/or mahogany is achieved. Further, the resultant decorative concrete structure 10 may be suitable for a backyard/patio decks, driveways, walkways, interior floors, or any other applications seeking the aesthetic appearance of the natural wood.

The above description is given by way of example, and not limitation. Given the above disclosure, one skilled in the art could devise variations that are within the scope and spirit of the invention disclosed herein, including various ways of cutting into the exposed surface 12 to create a pattern that resembles planks found in conventional natural wood decks. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of forming a decorative concrete slab having an exposed surface that resembles natural wood, the method comprising the steps of:
preparing a subgrade;
pouring a concrete mixture over the subgrade, the concrete mixture defining the exposed surface when poured;
brooming the exposed surface with a brooming tool in directions to create grain patterns to resemble the natural wood;
cutting a plurality of longitudinal cuts that are spaced from one another; and
applying a stain to the exposed surface.

2. The method of claim 1 wherein the step of cutting a pattern includes longitudinal cuts that are generally equally spaced and parallel to each other.

3. The method of claim 1 wherein the distance between each cut of the plurality of longitudinal cuts is approximately 5.5 inches.

4. The method of claim 1 wherein each cut of the plurality of longitudinal cuts has a depth of approximately between 0.125 inch to 0.375 inch.

5. The method of claim 1 wherein the groove has a width of approximately 0.1875 inch.

6. The method of claim 1 wherein the plurality of longitudinal cuts each defines a first and second wall that are generally parallel to each other.

7. The method of claim 1 wherein the plurality of longitudinal cuts each defines a first and second wall formed an angle with respect to each other.

8. The method of claim 1 wherein the step of applying stain on the exposed surface comprises applying more than one stain upon the exposed surface.

9. The method of claim 1 further comprising the step of adding a color additive to the concrete mixture prior to the pouring step.

10. The method of claim 1 further comprising the step of placing reinforcement members above the subgrade and pouring the concrete mixture over reinforcement members so that the reinforcement members are encapsulated within the concrete mixture.

11. The method of claim 10 wherein the reinforcement members are rebars or a wire mesh.

12. The method of claim 1 wherein the step of cutting is performed prior to the concrete mixture being cured.

13. The method of claim 1 wherein the step of cutting is performed after the concrete mixture has been cured.

14. The method of claim 1 further comprising the steps of:
preparing a concrete form for the decorative concrete slab, the concrete form defining a boundary of the decorative concrete slab;
striking off any excess of the concrete mixture to bring the exposed surface of the concrete mixture to a desired elevation;
finishing the exposed surface of the concrete mixture with a float tool; and
curing the concrete mixture to a desired curing period.

15. The method of claim 14 wherein the float tool is a metal bull float.

16. A decorative concrete slab having an exposed surface, the exposed surface comprising:
a plurality of longitudinal grooves disposed within the exposed surface of the decorative concrete slab being spaced and generally parallel to each other;
grain patterns formed by a brooming tool within the exposed surface that resembles natural wood; and
a stain applied to the exposed surface.
